(19) United States
(12) Patent Application Publication
(10) Pub. No.: US 2020/0396710 A1
(43) Pub. Date: Dec. 17, 2020

(54) METHODS AND DEVICES FOR CONFIGURATION OF SIGNALING ASSOCIATED WITH MULTIPLE AOA POSITIONING

(71) Applicant: TELEFONAKTIEBOLAGET LM ERICSSON (PUBL), Stockholm (SE)

(72) Inventors: Torbjörn WIGREN, UPPSALA (SE); lana SIOMINA, TÄBY (SE)

(21) Appl. No.: 16/957,218

(22) PCT Filed: Jan. 5, 2018
(86) PCT No.: PCT/IB2018/050083

§ 371 Date: Jun. 23, 2020

(51) Int. Cl. H04W 64/00; G01S 3/16; H04W 24/10; G01S 5/02

(52) U.S. Cl. CPC H04W 64/003; G01S 3/16; G01S 5/0215; G01S 5/0252; H04W 24/10

(57) ABSTRACT

A method of a radio network node for positioning a mobile device comprises, scheduling frequency resources in an angular positioning measurement configuration for two or more frequency bands, and initiating a request to the mobile device to perform positioning measurements for the two or more frequency bands according to the angular positioning measurement configuration. The method further comprises receiving a measurement report according to a reporting configuration in response to the request, the measurement report comprising the positioning measurements for the two or more frequency bands, and determining refined mobile position related information based on the measurement report.

### TECHNICAL FIELD

Certain embodiments relate, in general, to wireless networks and, more particularly, to configuring multiple angle-of-arrival (AoA) measurements and corresponding measurement reports for positioning of target stations in a wireless communication system.

### BACKGROUND

Location-based services and emergency call positioning drive the development of positioning in wireless networks. Positioning support in Third Generation Partnership Project Long Term Evolution (3GPP LTE) was introduced in Release 9. This enables operators to retrieve position information for location-based services and to meet regulatory emergency call positioning requirements. Positioning in LTE is supported by the network architecture 100 of FIG. 1, in which direct interactions between a user equipment (UE) 110 and a location server (E-SMLC) (e.g. a core network node), also referred to as a positioning node 130, are via the LTE Location Positioning Protocol (LPP). There are also interactions between the location server and the eNodeB 120 (e.g. a radio network node) via the LPPa protocol, which are to some extent supported by interactions between the eNodeB and the UE via the LTE-Uu interface, utilizing the Radio Resource Control (RRC) protocol. Furthermore, the positioning node 130 may or may not reside solely in a core network node, e.g. it may also be comprised in a radio network node, such that, the functionality of the positioning node may be partially in a radio network node 120 and partially in a core network node 130. Other protocols that support interactions between the various nodes are further noted. For example, the Mobility Management Entity (MME) interacts with the eNodeB 120 via the 51 interface, the location server E-SMLC via the SLs interface, utilizing the Location Services Application Protocol (LCS-AP), and the GMLC via SLg interface.

E-911 emergency positioning requirements have recently been tightened to a horizontal accuracy better than 50 m and a vertical accuracy better than 3 m, to handle indoor E-911 positioning. In addition, indoor positioning is one of the critical aspects in the roadmap of the development of 5G positioning, based on which certain next generation features should be enabled, for example, the internet of things (IoT). Currently available positioning methods are unable to support the new positioning requirements.

### SUMMARY

It is therefore desirable to provide a solution for improving positioning of mobile devices in wireless communications systems using multiple angle-of-arrival (AoA) measurements obtained in one antenna or node, to provide a better, more accurate, and more diverse radio measurement than existing positioning solutions. The object of the proposed solution is to provide signaling between the relevant nodes, e.g., UE and positioning node, for requesting multiple AoA measurements necessary for positioning and for sending associated measurement reports with multiple AoA measurements.

In a first aspect, the object is achieved by a method of a radio network node for positioning a mobile device. The method comprises, scheduling frequency resources in an angular positioning measurement configuration for two or more frequency bands, and initiating a request to the mobile device to perform positioning measurements for the two or more frequency bands according to the angular positioning measurement configuration. The method further comprises receiving a measurement report according to a reporting configuration in response to the request, the measurement report comprising the positioning measurements for the two or more frequency bands, and determining refined mobile position related information based on the measurement report.

In a second aspect, the object is achieved by a method of a mobile device for positioning of the mobile device. The method comprises, receiving an initiation request from a radio network node comprising an angular positioning measurement configuration for two or more frequency bands. The method further comprises, in response to the request, initiating measurements for the two or more frequency bands according to the angular positioning measurement configuration, and transmitting a measurement report according to a reporting configuration, the measurement report comprising the measurements for the two or more frequency bands.

In a third aspect, the object is achieved by a method of a radio network node for positioning a mobile device. The method comprises, scheduling frequency resources in a reference signal transmission configuration for two or more frequency bands, and transmitting an initiation request to the mobile device to perform uplink reference signal transmission according to the reference signal transmission configuration. The method further comprises processing received uplink reference signals from the mobile device for the two or more frequency bands, and determining refined mobile position related information based on AoA information related to the processed received uplink reference signals.

In a fourth aspect, the object is achieved by a method of a mobile device for positioning of the mobile device. The method comprises, receiving an initiation request from a radio network node comprising a reference signal transmission configuration for two or more frequency bands, and initiating reference signal transmission according to the reference signal transmission configuration.

Additional aspects are provided for a radio network node, a wireless device, and respective computer programs.

It is to be noted that any feature of any of the embodiments disclosed herein may be applied to any other embodiment, wherever appropriate. Likewise, any advantage of any of the embodiments may apply to the other embodiments, and vice versa. Other objectives, features and advantages of the enclosed embodiments will be apparent from the following description.

Generally, all terms used herein are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1 illustrates an exemplary network architecture for positioning a node.

FIG. 2 illustrates angle of arrival combined with timing advance (TA).

FIG. 3 illustrates an example of the geometry of angle of arrival.

FIG. 4 illustrates an exemplary embodiment of using multiple AoA for single node positioning.

FIG. 4a illustrates an exemplary embodiment of non-line of sight (LOS) positioning.

FIG. 5 illustrates a flowchart of a method of a radio network node for positioning a mobile device.

FIG. 6 illustrates a flowchart of a method of a mobile device for positioning the mobile device.

FIG. 7 illustrates a flowchart of a method of a radio network node for positioning a mobile device.

FIG. 8 illustrates a flowchart of a method of a mobile device for positioning the mobile device.

FIG. 9A-C illustrate block diagrams of exemplary radio network nodes.

FIG. 10A-C illustrate block diagrams of exemplary wireless devices.

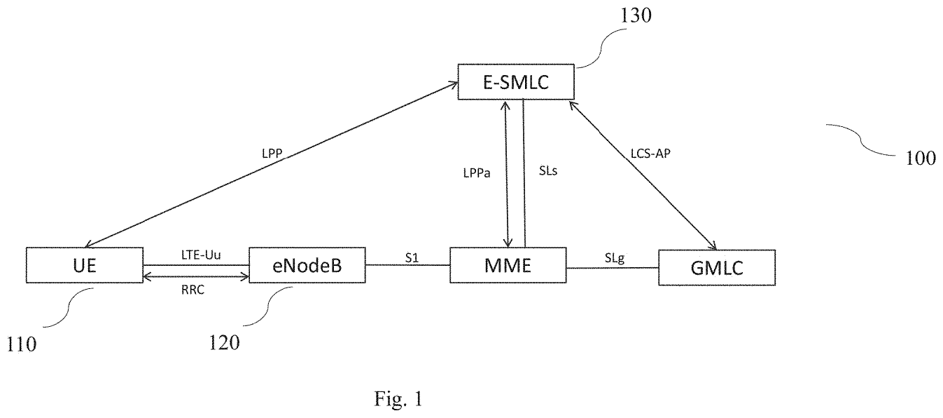

### DETAILED DESCRIPTION

Some of the embodiments contemplated herein will now be described more fully hereinafter with reference to the accompanying drawings. Other embodiments, however, are contained within the scope of this disclosure and the invention should not be construed as limited to only the embodiments set forth herein; rather, these embodiments are provided by way of example to help convey the scope of the inventive concept to those skilled in the art. If used, like numbers refer to like elements throughout the description.

One method for positioning of a mobile device is a so-called fingerprinting positioning approach. Fingerprinting positioning algorithms operate by creating a radio fingerprint for each point of a fine coordinate grid that covers the area associated with a Radio Access Network (RAN). The fingerprint may e.g. consist of the cell Ids that are detected by a mobile device in each grid point, quantized path loss or signal strength measurements with respect to multiple eNodeBs, performed by the mobile device, quantized round-trip time (RTT), radio connection information, etc., for each grid point. An associated ID of the eNodeB may also be needed. The fingerprint may also comprise a quantized timing advance (TA), in each grid point.

In an example of a fingerprinting method, when a positioning request arrives, a radio fingerprint is first measured, after which the corresponding grid point is looked up and its corresponding geographical coordinates are reported. This of course requires that the point is unique.

Because the fingerprinting algorithms usually decide the location by searching for the reference point in the radio map that most closely resembles the measured radio characteristics, the positioning accuracy may be compromised using measurements that do not accurately represent the wireless channel. In practice, the real measurements, compared to those indicated in the fingerprint, may vary significantly due to for example a time-varying wireless channel.

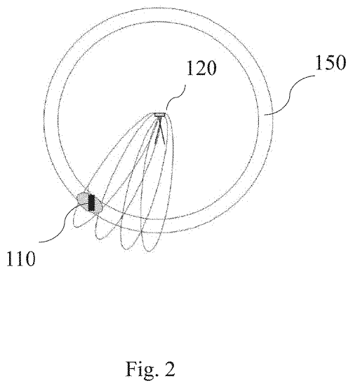

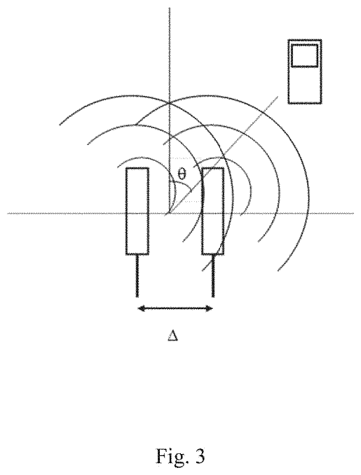

Another type of positioning method uses a single angle-of-arrival (AoA) to determine the position of a device. The AoA measurement standardized for LTE is defined as the estimated angle of a UE with respect to a reference direction which is the geographical north, positive in the clockwise direction. The AoA can reduce the angular uncertainty, as compared to cell ID and timing advance (TA) positioning, if combined with TA as illustrated in FIG. 2, where TA 150 defines the circle around the eNodeB.

Using a single AoA approach, the direction of the eNodeB antenna is assumed to be known, hence the AoA can be obtained by measuring an angle of transmission of a beam of radio energy, relative to the antenna direction. In one example, the UE uses pre-coding, to transmit in a certain direction relative to the antenna. Each direction is marked with a pre-coding index. The eNB transmits the available indices (pre-coded accordingly) and the UE measures on each of these and determines the best one in terms of the signal to noise and interference ratio (SINR), and reports back to the eNodeB. That feedback then defines the direction with the best SINR, and thusdefines the AoA. An example of the geometry of AoA is further depicted in FIG. 3, where θ represents the angle of the transmission beam from the eNBs 120 to the UE 110, and Δ represents the distance between the two eNBs 120.

The solution proposed herein is based on multiple AoA measurements in a fingerprint positioning method. The method may be performed both to generate multiple AoA fingerprints associated with multiple locations within a mapped area (i.e. to create a radio map), and then also may be performed for actual positioning based on multiple AoA measurements associated with the mobile device to be positioned.

Using multiple AoA measurements addresses problems with current positioning methods resulting from the characteristics of radio signal transmission. For example, a received radio signal fades differently for different parts of the frequency band. Therefore, the part of the signal that travels along a line of sight is strong in certain subbands of the channel and weak in others. Further, other parts of the signal that travel via reflected paths fade differently, and therefore, are strong in some subbands of the channel and weak in other subbands. Taking a measurement of AoA over a larger part of the frequency band of the channel may result in multiple AoAs—particularly in the case there is a significant multipath propagation. The latter condition is a typical one for radio propagation at high carrier frequencies.

Additional advantages of the multiple AoA positioning method is that it is able to provide very accurate indoor positioning, without a need to co-ordinate measurements between different nodes (e.g. 5G eNodeBs), i.e. single node positioning. The multiple AoA positioning method can also exploit 5G beamforming gains at high carrier frequencies, obtained by application of massive antenna array technology, which results in a very good coverage and very good detection properties of multiple AoAs. Further, AoA measurements are much more stable than the frequency properties of the channel, at a certain location. Positioning performance can therefore be expected to be very stable. The proposed positioning solution significantly improves the positioning accuracy of fingerprinting location algorithms, and can be implemented without requiring any special hardware.

The multiple AoA positioning method relies on the fact that radio rays are impinging on a receiving antenna from different directions. These rays must therefore intersect at a point where the UE is located, or where the radio transmission from a UE originated, when the AoA measurements are obtained based on signals transmitted by the same radio node. Reciprocity, discussed below, further provides that the same can be true in the downlink as in the uplink. The direction of transmission arrivals is, at least initially, obtained by measurement of certain received reference signals from the transmitting nodes, which may be either a UE or a radio network node.

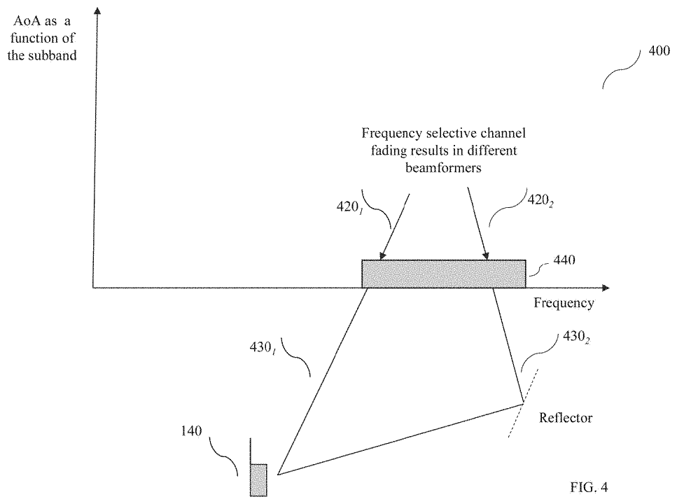

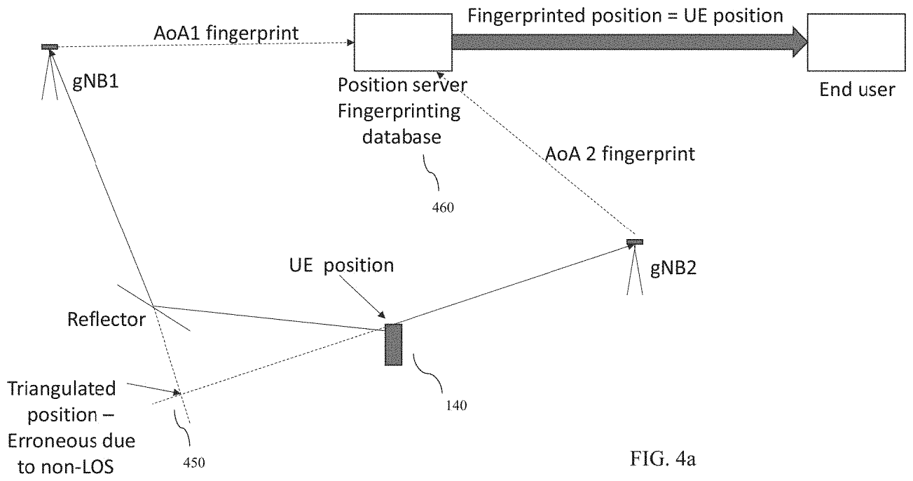

FIG. 4 illustrates embodiments of multiple AoA positioning method 400 using a single node for positioning. FIG. 4, for example, illustrates an embodiment in which a unique location of UE 140, e.g. a unique Cartesian position, can be determined from multiple AoAs. In this embodiment, frequency selective channel fading results in different beamformers for different subbands across a frequency band. The transmitting node, e.g. radio network node 120, operates with beamforming 440, and generates two different signals to UE 140 using different beamformers 420_{1,2}. However, note that the solution is not limited to two beamformers, and may support multiple beamformers which are dependent on the configuration of the radio network node 120. In this example, beamforming produces different signals with different directionality, i.e. transmission rays 430_{1,2}. Further in this embodiment, the different beamformers select different subbands for transmitting the respective signals. The radio network node receives feedback indicating different beamformers 420_{1,2} in different subbands, with these beamformers corresponding to different AoAs. In one case, the AoA associated with each beamformer may be considered as a function of a subband. As shown in FIG. 4, since both transmission rays 430_{1,2} from the radio network node terminate at the mobile device location, the Cartesian location of the mobile device may be characterized by the two AoAs associated with the transmission rays 430_{1,2}.

Locally, this would provide a unique localization for the mobile device. This follows since in other cases, e.g. when the STA is moving toward the radio network node, the beamformer would also need to change in order for the transmission to arrive at the mobile device's antenna, thus again providing a unique localization for the STA based on the new AoAs.

In another embodiment, the AoA may be determined in combination with another technique, denoting sounding. This technique is based on the assumption of reciprocity that is applicable if the uplink and downlink share the same frequency band, i.e. TDD access is assumed. In this case, the directions from which the highestradio signal power are received, e.g. directions with the strongest radio signals, are then the same in the uplink and the downlink. This implies that the receive directions, as measured in the eNB, will be the same as the preferred transmit directions, and thus, the AoA could similarly be determined from uplink measurements.

When using uplink measurements, the LTE eNB (or 5G equivalent base station) may configure the UE to transmit reference signals, referred to as sounding reference signals (SRSs) in LTE systems. The reference signals may be transmitted with a sufficient beam width so that the AoA is captured in the eNB receiver. The serving eNB then measures the signals impinging on all antenna elements of its antenna array, from which the AoA can be computed. Together with the known antenna direction and location, the AoA measurements can be determined in a suitable location coordinate system.

Different multiple AoAs may result from performing measurements on different beams and/or at different times, even for the stationary UE, e.g., due to fading and/or dynamic beam (re)configuration and/or beam sweeping. The beams may also be formed on different parts of the system bandwidths, i.e. different subbands. Further, an AoA measurement may comprise one or two types of angles—horizontal and vertical, so for the two types of measurements, one angle is the same, while the other one may be different. Therefore, the multiple AoA measurements between UE and a radio node (in DL or UL) can be associated with one or more of:
different parts of the channel bandwidth (especially relevant when the bandwidth is large as it is in 5G and at high frequencies), e.g., different subbands,
different antenna beams (DL or UL) formed by the UE,
different antenna beams (DL or UL) formed by the radio node, and
different antenna beam configurations used at different times, even for the same beam or with different beams

The multiple AoA measurements may comprise at least two or more AoA measurements of the same type, such as, two or more horizontal AoA measurements, two or more vertical AoA measurements, two or more AoA measurements representing both horizontal and vertical components, etc. Multiple types of AoA measurements are also not precluded, e.g., two or more horizontal AoA and at least one vertical AoA, etc. Since this situation is not always the case, the method may be complemented with e.g. a time measurement.

To generate a “radio map” based on multiple AoA measurements, a fingerprint positioning method may employ surveying over certain indoor reference points, thereby creating an indoor map denoting the multiple AoA measurements in each reference point. Each measurement may further be associated with a distinguishing characteristic (e.g., associated part of the channel bandwidth, beam index, beam pair index, etc.). The set of AoA measurements at each reference point can thus serve as a signature, or part of a signature, of the corresponding radio characteristic. The procedures for radio map surveying are used to build the reference radio map, with multiple AoA measurements. The multiple AoA fingerprint positioning method thus provides for indoor Cartesian positioning using only AoA information derived from a single antenna. The fingerprinting method can build only on multiple AoA measurements associated with the same node, or can be applied in combination with, e.g. timing advance (TA) measurements in 3GPP 5G positioning nodes.

The multiple AoA positioning method requires obtaining multiple AoA measurements, not currently supported. The emerging 5G standard defines primarily 2 types of pilot signals that are suitable for multiple AoA measurements. These 5G pilot signals are the counterparts to LTE and/or 3GPP CSI-RS downlink signals, denoted herein as CSI-RS equivalents, on which the UE is measuring. However, note that the naming of the pilot signals is likely to be changed in the ongoing standardization of 5G wireless in 3GPP, while purpose and/or functionality of the pilot signals may be the same. Hence, some signals may be referred to as “equivalents” of a currently named signal, e.g. CSI-RS equivalent; however, reference to any particular named signal, e.g. CSI-RS, is intended to include the named signal and any equivalents, and is not intended to limit the scope of the invention to only the currently named signal. Further, the reference to using CSI-RS and CSI-RS equivalent signals for multiple AoA measurements is not intended to be limiting and any of the following signals may be used for performing multiple AoA measurements: positioning reference signals, synchronization signals, physical signals comprised in Synchronization Signal (SS) block or SS/Physical Broadcast Channel (PBCH) block (e.g. Primary SS (PSS) or Secondary SS(SSS) or PBCH DeModulation Reference Signal (DM-RS)), CSI-RS, and CSI-RS equivalent signals, DM-RS, Phase Tracking Reference Signal (PT-RS), tracking reference signals or signals used for time frequency tracking (TRS), or other reference signals which may be used for positioning, including equivalents of any of the above signals.

There are a large number of such pilot signals and these can be beamformed with all the available well-known techniques. Thus, an eNodeB performing positioning may set up a scan where a certain CSI-RS equivalent is directed in a number of azimuth directions, i.e. beams. A UE may then be configured for positioning and for measuring on the CSI-RS equivalent signals for each of the scanned directions. The direction for which the best signal-to-interference noise ratio (SINR) is obtained then defines a beam direction. The best SINR is simply one way to determine which signal has the best channel quality compared to the SINR of signals measured from other directions. Other methods of measuring signal quality may be used, and as with SINR, the measurement indicating the best signal according to the type of measurement taken, is determined as compared to signals measured from other directions using the same type of measurement. The measurement reporting from the UE may take the form of an encoded and transformed quality measure, like the channel quality indicators (CQIs) of the LTE system. This way, the reporting allows for measuring in multiple azimuth directions, storing the directions which are below a configurable threshold, and using these for generation of the sought multiple AoAs. Further processing described below can then be used to generate the fingerprint, associated with the AoAs.

An alternative to using CSI-RS signals, or their equivalents, for multiple AoA measurements is to use uplink sounding reference signals (SRS) specified for 5G, herein denoted SRS equivalents. However, it is noted that since the coverage at high 5G carrier frequencies in the uplink is not expected to be good, special measures may be needed to ensure a good enough coverage when using uplink SRS for positioning. In the uplink alternative, an eNodeB configures a UE to transmit SRS, or equivalents, in multiple limited frequency bands, spread out over the channel, and further, to not transmit at all outside these bands. Correspondingly, the UE power boosting needs to be configured for multiple AoA measurements, in said limited frequency bands. An advantageous effect of this is an enhanced power spectral density which ensures that the AoA estimation algorithms applied will experience an enhanced SINR. The beamforming gains of the many prior art methods ranging from the discrete Fourier transform to superresolution methods like ESPRIT and MUSIC may contribute further to the AoA estimation.

Multiple AoA measurements are not supported by the currently available reporting formats which are transmitted between the mobile devices and radio network node and/or positioning node. Further, measurement procedures for multiple AoA measurements may not be available, in particular, measurement procedures that utilize beam forming gains of the antenna array for the direction finding or AoA measurement procedures for hybrid or analog beamforming or beam sweeping.

A positioning measurement is distinguished from a radio measurement. A positioning measurement is a measurement performed based on one or more radio signals or radio signal instances intended for UE positioning purpose. A radio measurement may be associated with a measurement identity and may also be associated with a specific purpose such as positioning or location services. For downlink positioning measurements, a UE is configured to receive downlink radio signal(s) for performing the measurement. For uplink measurement, a UE is configured to transmit radio signal(s) to enable the measurement at a radio network node or at another UE.

Therefore, to support multiple AoA positioning measurements and reporting these positioning measurements, additional configuration of the UEs, radio network nodes, and positioning nodes is necessary. Configuration of the UE to perform multiple AoA measurements, by the UE, may include determining parameters for measurement configuration and reporting. For example, the UE may be configured to perform multiple AoA measurements using beamformed CSI-RS equivalent measurement reporting or more generally beamformed downlink (DL) signals (or DL signals transmitted and associated with specific beams). Configuration of the UE may be determined by the network (e.g., gNodeB, eNodeB, positioning node, etc.) and/or by the UE (e.g., using a pre-defined configuration or deriving a configuration based on a predefined rule). In an embodiment, configuration of the UE by the network may comprise sending a positioning measurement request comprising a positioning measurement indicator, and associated parameters for measurement configuration and reporting (e.g., DL signal configuration, measurement periodicity, reporting periodicity, time and/or frequency resources, etc.). In an embodiment, the positioning measurement indicator indicates to the UE that the information provided is solely related to positioning measurement configuration.

Configuration is further required to support the UE transmitting SRS, or SRS-equivalent, narrowband transmission (or more generally UL transmission), for multiple AoA measurements. This configuration may be performed by the network (e.g., gNodeB, eNodeB, positioning node, etc.) and/or by the UE (e.g., using a pre-defined configuration or deriving a configuration based on a predefined rule). In one embodiment for positioning using UL measurements, the network configuration of the UE comprises a UE transmission configuration and the associated parameters, and may also comprise a positioning sounding indicator. In one example, the positioning sounding indicator indicates to the UE the information provided is related to sounding configuration for the purposes of positioning, as opposed to sounding configuration for the purpose of general channel estimation. The UE transmission configuration provides information for a UE to transmit positioning reference signals according to the transmission configuration, and where the network performs UL positioning measurements on those UL positioning reference signals. Network configuration of the SRS may include the positioning sounding indicator, and associated parameters related to the frequency bands of the uplink transmission (e.g., time and/or frequency resources, transmit power, periodicity, pattern, transmit timing reference, a power control parameter, etc.). The configuration of the SRS transmission by the UE includes configuring parameters for the UL transmission.

The configuration of any of the above systems features may be performed via dedicated signaling, multicast or broadcast, physical layer (e.g., control channels) and/or higher layers (e.g., radio resource control (RRC)) signaling.

Further, the system may be configured to obtain multiple AoA measurements (e.g., by the network or UE) in the frequency bands configured for AoA measurements, by application of standard AoA estimation methods. Note that the frequency bands configured for AoA measurements are assumed to be located in separate parts of the channel so that the different fading makes it likely to detect multiple AoAs. The system is thus able to process the AoA measurements in each of the bands to extract the multiple AoAs that are detected to be “significant”, with respect to pre-configured thresholds.

Using multiple AoAs for fingerprint positioning addresses one of the most significant issues with current positioning solutions, namely that of non-line-of-sight (non-LOS) propagation. Non-LOS propagation means that a radio beam hits an obstacle and changes direction before it hits the direction of arrival receiver. Unless additional information is available, e.g. multiple AoAs, there is no way for the receiver to tell from which geographical position the signal originated, which is necessary for accurate positioning. This also applies in the example in which two non-co-located base stations attempt to triangulate the position of the transmitter, e.g. a mobile device. As will be shown, the multiple AoA fingerprinting method solves this problem since the geographical locations have been surveyed and stored in the fingerprinting database, and therefore, positioning using the fingerprinting method provides the ability to associate the detected angles of arrival with the correct geographic position.

FIG. 4a depicts an exemplary non-LOS propagation situation where a UE 140 communicates with two gNBs, e.g. gNB1 and gNB2. The radio link between gNB1 and gNB2 is subject to a reflection such that gNB1 does not measure the correct geographical direction to the UE. The radio link between the UE and gNB2 is however a line of sight link, without any reflection so gNB2 does measure the correct direction to the UE 140. In a first example where multiple AoA fingerprinting is not used, since the radio signals from the UE 140 must have come from the same geographical position, assuming close to simultaneous transmission to gNB1 and gNB2, a positioning calculation algorithm may assume LOS between the UE and both gNB1 and gNB2. In that case, the positioning calculation algorithm may determine the UE position to be where the rays i) from gNB1 to the reflector and continuing in the same direction behind it along the dashed line, and ii) from gNB 2 to the UE and continuing behind the UE along the dashed line, intersect at point 450. As is shown in the figure, point 450 is not the correct position of UE 140. However, in an embodiment of the solution proposed herein, a multiple-AoA fingerprinting positioning method would instead interpret the AoAs measured in gNB1 and gNB2 as fingerprints. During the fingerprinting surveying phase in which the radio map is created, a test UE would therefore have been in the position of the UE 140 in FIG. 4A during the surveying phase process, and consequently, due to the resulting radio map, the position of the test UE is captured and thus, known. As such, the fingerprint of the measured AoAs would be associated with the correct position of the UE 140 of FIG. 4a, and stored in the Position Server Fingerprinting database 460. The consequence of this is that when the UE 140 of FIG. 4a is positioned with a fingerprinting method, the correct mobile device position, even in non-LOS situations, can be determined and retrieved from the Positioning Server Data Base, and signalled to the end user.

A positioning node in the proposed solution may be comprised, depending on the system archictecture, e.g. in a radio network node (e.g., radio base station (RBS), eNB, 5G gNB, radio network controller, etc.) or core network node (e.g, an E-SMLC).

In order for the system 100 to perform a fingerprinting positioning method using multiple AoA measurements, the system must be able to request and receive AoA measurement reports, and, correspondingly, generate and send the AoA measurement reports. Thus, new communications between mobile devices that are to be positioned and the radio network nodes in communication with these mobile devices, are necessary to support the functions of the fingerprinting positioning method.

New signaling, e.g. reference signal(s), is further defined so that a measuring node is able to identify the signaling as being associated with a positioning method using multiple AoA measurements. The definition of the new signals, which includes allocation of the signaling resources, is used by a measuring node to take the requested measurements, and is further referred to as “angular positioning measurement configuration.” The angular positioning measurement configuration defines information for transmitting and/or receiving positioning reference signals by the mobile devices and the radio network nodes, and for performing corresponding positioning measurements, during the course of performing a fingerprinting positioning method.

In an embodiment in which the measuring node is a mobile device 110 (e.g. UE), the positioning functionality in the radio network node 120, e.g. a RAN (or in some embodiments, at least partially in the core network, for example, in an Evolved Core Network (ECN)) causes the scheduler of the particular radio network node 120 (e.g. eNB) to send information to the UE regarding where to perform measurements, e.g. the time and frequency resources. In another embodiment in which the measuring node is a radio network node 120, the radio network node 120 provides the same information to the mobile device 110 as it does when the UE is the measuring node. However, in this embodiment, the information, on receipt by the UE, is treated as positioning measurement instructions that indicate on which resources the UE is to use for transmitting positioning reference signals, and correspondingly indicates on which resources the radio network node, acting as the measuring node, will use for measuring to determine the multiple AoA measurements.

In an embodiment when the UE is the measurement node, the angular positioning measurement configuration comprises information regarding the type of reference signal to measure, the resources allocated for the reference signal, and the number and identification of the frequency subbands associated with each of the multiple AoA measurements to be taken. For example, the type of reference signal indicated may be a synchronization signal, reference signal, channel state information reference signal (CSI-RS), positioning signals (or other signals which may be used for positioning purposes), DMRS, TP-RS, TRS, or equivalents of any of these types of signals. The resources allocated in the angular positioning measurement configuration indicate to a measuring node the time and/or frequency resources on which the measuring node may perform measurements (e.g. when the measuring node is a radio network node or other network positioning node), or time and/or frequency resources or a resource pattern of the downlink (DL) signals transmissions to be measured (e.g. when the measuring node is a UE). The angular positioning measurement configuration also identifies the two or more frequency subbands associated with each of the multiple AoA measurements to be taken.

The signaling resources, defined in the angular positioning measurement configuration, are typically defined during scheduling of radio resources, since it is normally the scheduling functionality that takes part in the final allocation of these resources, but in other embodiments, the signaling resources may be defined in advance of scheduling.

The angular positioning measurement configuration may also comprise one or more the following: measurement periodicity, number of subframes on which to measure either consecutively or non-consecutively and which have been configured by the transmitting node as being available for measurements, measurement bandwidth, transmission bandwidth of the DL signals to be measured, muting pattern or indication of when the configured DL signals may actually not be transmitted, DL transmit antenna configuration, beam configuration (e.g., beam width, beam direction, etc.), configuration index (e.g., referring to a set of pre-defined parameters for the angular positioning measurement configuration), or any other information relevant to taking positioning measurements based on the angular positioning measurement configuration. The angular positioning measurement configuration may further include a positioning measurement indicator.

In an embodiment in which the radio network node (or other network node) is the measuring node, the UE receives a reference signal transmission configuration defining uplink (UL) transmission configuration information to enable multiple AoA measurements at the network side. In an embodiment, the reference signal transmission configuration defines time and/or frequency resources or pattern for the UL transmissions and/or signals, and the two or more frequency subbands associated with the multiple AoA measurements. The reference signal transmission configuration may also define one or more of the following: transmission bandwidth, transmit power, a power control parameter, transmission periodicity, transmission triggering event configuration, UE transmit beam configuration, or UE antenna configuration, to be used for the UL transmission, etc. In another embodiment, the reference signal transmission configuration may comprise a configuration index that refers to a pre-defined parameter set for the positioning request. The reference signal transmission configuration may further include a positioning sounding indicator.

Further, in order for a measuring node to report multiple AoA positioning measurements, how the measuring node generates and transmits the measurement report must also be configured. Generally, a measurement reporting configuration is used by the measuring node to report multiple AoA measurements corresponding to a particular angular positioning measurement configuration. The measurement reporting configuration may define one or more of the following characteristics associated with a measurement report: reporting periodicity, reporting event configuration, uplink (UL) resources and scheduling for transmitting the measurement reports from the measuring node. In an embodiment, the reporting event configuration defines the format for reporting multiple AoA measurements associated with the two or more frequency bands to be measured. In an embodiment, the measurement reporting configuration may comprise a configuration index referring to a set of pre-defined parameters for multiple AoA measurement reporting.

The technical effect of these procedures is to make use of multiple AoA information to compute the sought location of the user with an improved accuracy (a less accurate position may be known, e.g. by registering the identity of the cell or beam to which the UE is connected). This location with improved accuracy may be denoted “refined position related information.” The refined position related information may be a unique location e.g. a unique Cartesian position, in the radio map, identified by a fingerprint based on multiple AoA measurements associated with multiple frequency bands/subbands. In one example, a frequency band is an E-UTRA operating band as specified in 3GPP TS 36.101 (2017-12) or similar; or an operating band as specified in 3GPP TS 38.101-1, 38.101-2, or 38.101-3 (Rel-15, v1.0.0, 2017-12) or similar. In another example, a frequency band is more generally a part of or a block of frequency resources in the frequency spectrum. Two frequency blocks may be two non-overlapping parts of the frequency spectrum. A frequency band may comprise contiguous or non-contiguous set of frequency resources.

Following are exemplary embodiments of the requesting and receiving, and generating and transmitting, positioning measurement reports with multiple AoA measurements.

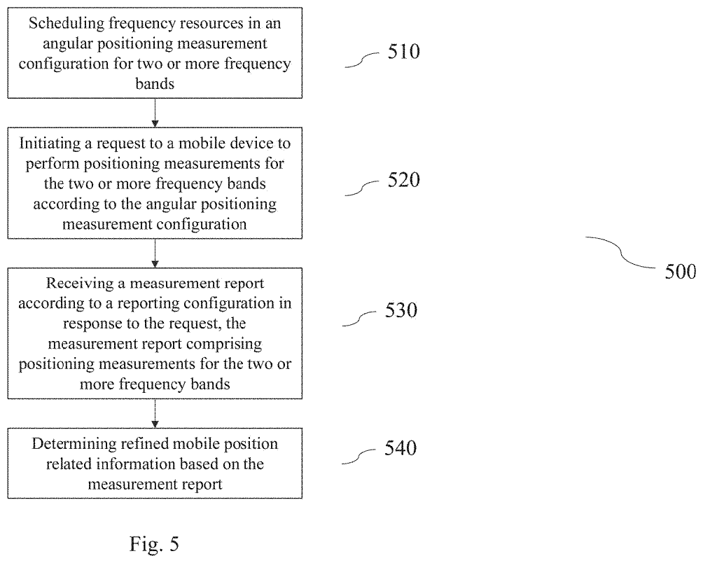

FIG. 5 provides a flowchart of an embodiment of a method 500 for positioning a mobile device. In this embodiment, the radio network node requests positioning measurements from the mobile device (i.e. the measuring node) based on transmitted downlink (DL) signals. At step 510, radio network node, e.g. radio network node 120, schedules frequency resources in an angular positioning measurement configuration for two or more frequency bands on the downlink. In an embodiment, the scheduling may be in response to a positioning request from the mobile device or from a positioning node. The radio network node, at step 520, then initiates a request to the mobile device, e.g. mobile device 110, to perform positioning measurements for the two or more frequency bands according to the angular positioning measurement configuration based on transmitted downlink signals. The request sent to the mobile device comprises the angular positioning measurement configuration, which defines the information necessary for the mobile device to take the proper measurements for positioning. The radio network node, at step 530, receives a measurement report from the mobile device in response to the request arranged according to a reporting configuration. The received measurement report comprises positioning measurements for the two or more frequency bands indicated in the angular positioning measurement configuration. In an embodiment, the measuring report comprises AoA related information for a least two subbands, and when the number of frequency bands is more than two, the measurement report may comprise AoA related information for a subset of the frequency bands, where the number of frequency bands in the subset is at least two. At 540, the radio network node determines refined mobile position related information based on the measurement report, e.g. a position of the mobile device. In some embodiments, the refined mobile position information may be provided to a positioning node. In an embodiment, the positioning node and the radio network node are separate nodes.

In an embodiment, the refined mobile position related information may be used to construct a multi-band angle-of-arrival (AoA) fingerprint, and in other embodiments, may be used to determine a position of the mobile device based on the multi-band AoA fingerprint. For example, the multiple AoA estimates are intended to be used with a fingerprint positioning method. In a fingerprint positioning method, a mobile device's location is determined based on comparing its measured characteristics, which includes at least multiple AoA estimates, to a radio map of the area, generally an indoor space, such as, an office building, or stadium, etc. The radio map itself comprises fingerprinted positions that define locations of the mapped area, i.e. the radio map. Each fingerprinted position in the radio map is associated with fingerprinted reference measurements. The radio map may be generated, for example, by performing an extensive surveying operation that performs fingerprinting radio measurements repeated for all coordinate grid points (referred to as a fine grid). The generation of the fingerprinted positions is not limited to the fine grid approach. Indeed, other approaches to capturing radio measurements and generating fingerprinted positions may be used when creating a radio map. In any of the approaches utilized for generating the database of fingerprinted conditions, however, the collection of fingerprints usually relies on the reference measurements performed through a test mobile device. Thus, the mechanism for creating the reference points of the radio map may be similarly used to collect AoA measurements when performing an actual positioning a device using the radio map.

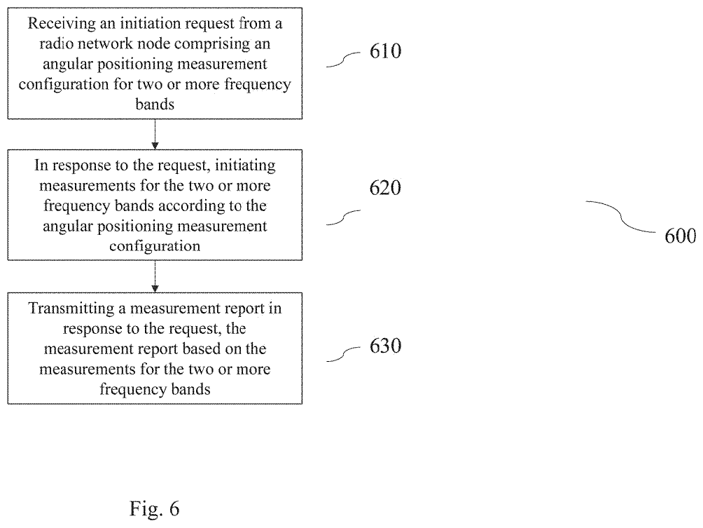

FIG. 6 provides a flowchart of an embodiment of a method 600 for positioning a mobile device. In this embodiment, the mobile device (i.e. the measuring node) processes a request for positioning measurements from a radio network node based on transmitted downlink (DL) signals. At step 610, the mobile device receives an initiation request from a radio network node comprising an angular positioning measurement configuration for two or more frequency bands. In an embodiment, receiving the initiation request is in response to a positioning request from the mobile device or a positioning node. At 620, in response to the request, the mobile device initiates measurements for the two or more frequency bands according to the angular positioning measurement configuration. The angular positioning measurement configuration for two or more frequency bands indicates the resources to be used for performing the measurements. In an embodiment, initiating measurements comprises measuring received downlink reference signals transmitted according to the angular positioning measurement configuration, wherein the angular positioning measurement configuration identifies the resources scheduled for the downlink reference signals for the two or more frequency bands. In another embodiment, measuring received downlink reference signals transmitted according to the angular positioning measurement comprises processing the received downlink reference signals to determine AoA related information for at least a subset of the frequency bands. At 630, the mobile device transmits a measurement report further in response to the request, the measurement report based on the measurements for the two or more frequency bands. In an embodiment, the measurement report is used to construct a multiple angle-of-arrival (AoA) fingerprint or to determine a position of the mobile device based on multiple AoA measurements.

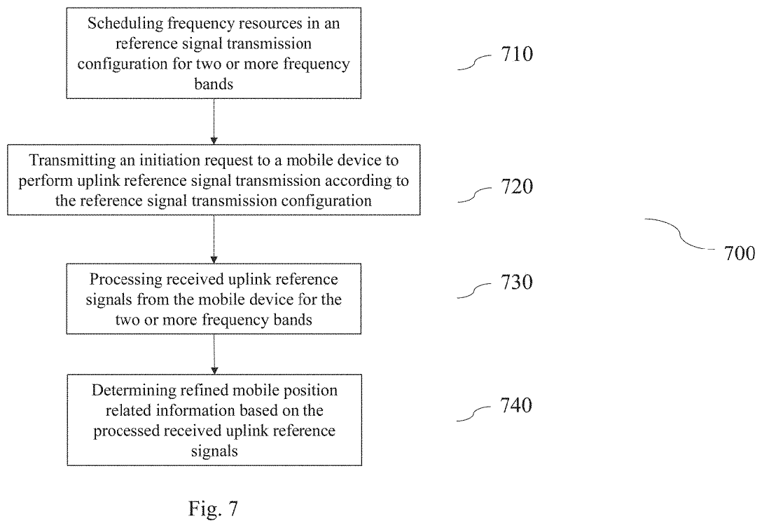

FIG. 7 provides a flowchart of an embodiment of a method 700 for positioning a mobile device. In this embodiment, the radio network node (or other network node) is the measuring node and the measurements are taken on uplink reference signals transmitted by the mobile device. At 710, the radio network node schedules frequency resources in a reference signal transmission configuration for two or more frequency bands. At 720, the radio network node transmits an initiation request to a mobile device to perform uplink reference signal transmission according to the reference signal transmission configuration. At 730, the radio network node processes received uplink reference signals from the mobile device for the two or more frequency bands. In an embodiment, processing received uplink reference signals comprises determining AoA related information for a subset of the two or more frequency bands. In another embodiment, the received uplink reference signals are SRS or SRS equivalent signals, DM-RS, PT-RS, Random Access Channel (RACH), or other uplink signals that may be used as uplink reference signals for positioning measurements. The uplink reference signals are received in response to the initiation request sent to the mobile device. At 740, the radio network node determines refined mobile position related information based on the measurement report, e.g. a position of the mobile device.

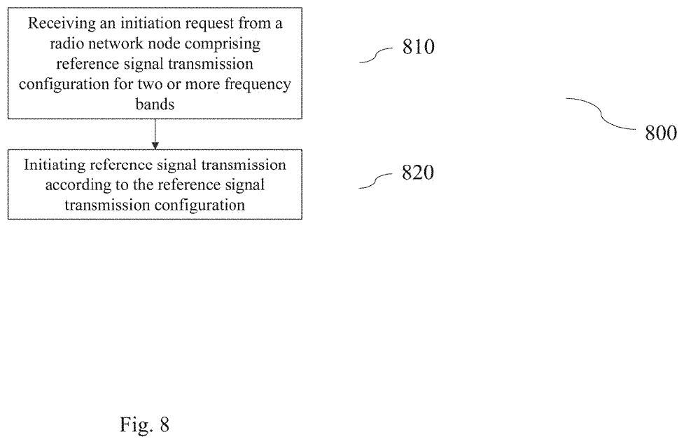

FIG. 8 provides a flowchart of an embodiment of a method 800 for positioning a mobile device. In this embodiment, the mobile device is configured to transmit uplink reference signals to be measured by a network measuring node. At 810, the mobile device receives an initiation request from a radio network node comprising a reference signal transmission configuration for two or more frequency bands. At 820, in response to the request, the mobile device initiates reference signal transmission according to the reference signal transmission configuration. In an embodiment, initiating reference signal transmission comprises transmitting a reference signal for each frequency band of the two or more frequency bands. The transmitted reference signals may be SRS or SRS-equivalent signals.

The positioning (i.e. determining the position a mobile device) may be performed by a radio network node, as in some of the embodiments described above. For example, the radio network node may receive measurements of DL signals taken by the mobile device, or may take measurements on UL signals transmitted by the mobile device. But in other embodiments, the positioning of the mobile device may be performed by the mobile device itself. For example, the mobile device may take measurements of DL signals or may receive measurements taken by a radio network node on UL signals transmitted by the mobile device. Some embodiments of the mobile device performing positioning are disclosed below.

In an embodiment when positioning of the mobile device is performed in the mobile device, based on DL measurements, a radio network node schedules frequency resources in an angular positioning measurement configuration for two or more frequency bands and transmits scheduling data of the frequency resources for the angular measurement and/or an initiation request to the mobile device to perform positioning based on transmitted downlink (DL) signals organized according to the angular positioning measurement configuration. The radio network node further receives a position report comprising the position of the mobile device. In an embodiment of the method, the downlink reference signals are any of: positioning reference signals, synchronization signals, physical signals comprised in Synchronization Signal (SS) block, Demodulation Reference Signal (DM-RS), Phase Tracking Reference Signal (PT-RS), tracking reference signals or signals used for time frequency tracking (TRS), CSI-RS or CSI-RS equivalent signals.

In a further embodiment in which a mobile device performs positioning of the mobile device, based on DL measurements, the mobile device receives an initiation request from a radio network node to perform positioning based on downlink (DL) signals transmitted according to the angular positioning measurement configuration for two or more frequency bands. The mobile device initiates positioning measurements on the received DL signals transmitted according to the angular positioning measurement configuration. The mobile device then determines refined mobile position related information based on the positioning measurements, and transmits the refined position related information to a positioning network node in a position report according to a reporting configuration, e.g. when the positioning network node and the radio network node are separate nodes. However, in some embodiments, the positioning network node and the radio network node may be the same node, and then the position report is sent to the combined node. In an embodiment in which complete positioning is performed in the mobile device, the the mobile device further obtains a subset of a fingerprint database to be used for positioning, determines a position of the mobile device using the subset of the fingerprint database and the refined mobile position related information, and transmits a position report to a positioning network node, comprising the determined position.

In an embodiment, a positioning network node may request positioning of a mobile device. The positioning network node transmits a positioning request to a radio network node associated with a mobile device, the positioning request indicating a request for the mobile device to perform mobile based positioning based on AoA in two or more frequency bands. The positioning node subsequently, in response to transmitting the positioning request, receives, via LTE Positioning Protocol (LPP), a position report from the mobile device, comprising the determined mobile position. In an embodiment when complete positioning is performed in the mobile device, the mobile device obtains at least parts of a fingerprint database to be used for positioning; and determines the position of the mobile device using the fingerprint database and the refined mobile position related information. The mobile device further transmits a position report to the positioning network node, comprising the determined position. In a further embodiment, the position report is transmitted via an LPPa protocol message.

In another embodiment, the positioning network node transmits a positioning request to a radio network node associated with a mobile device, indicating a request to perform network node based positioning of the mobile device based on AoA in two or more frequency bands. The positioning network node subsequently, in response to transmitting the positioning request, receives a position report from the network node, comprising the determined mobile position. In a further embodiment, the position report is received via an LPPa protocol message.

In some cases, positioning of a mobile device is performed in the positioning node, with data received from a base station node over LPPa in LTE. In an embodiment, the positioning node transmits a positioning request to a radio network node associated with the mobile node, comprising a request for network node based positioning based on measurements in two or more frequency bands. The positioning node receives, e.g. via LPP, refined mobile position related information from the radio network node. In another embodiment, the refined mobile position related information is received via an LPPa protocol message.

In other cases, positioning of the mobile device is performed in the positioning node, with data from UE over LPP in LTE. In an embodiment, the positioning node transmits a positioning request to a radio network node associated with the mobile device, the request indicating mobile device based positioning based on AoA in two or more frequency bands. The positioning node receives, via an LPP protocol (e.g. LPPa), refined mobile position related information from the mobile device.

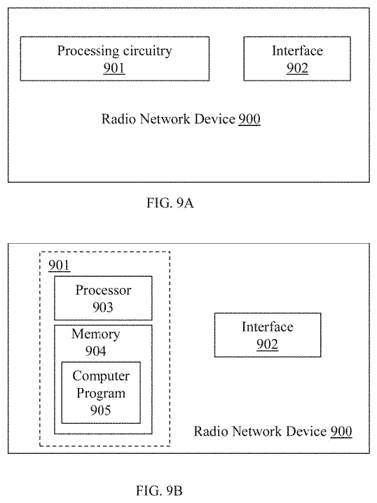

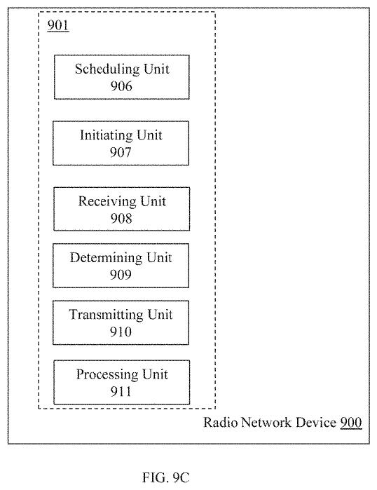

Exemplifying embodiments of a radio network node are illustrated in a general manner in FIG. 9A-9C. The components of radio network node 900 are depicted as single boxes located within a single larger box. In practice however, a radio network node may comprise multiple different physical components that make up a single illustrated component (e.g., interface 902 may comprise terminals for coupling wires for a wired connection and a radio transceiver for a wireless connection). Similarly, radio network node 900 may be composed of multiple physically separate components (e.g., a NodeB component and a RNC component, a BTS component and a BSC component, etc.), which may each have their own respective processor, storage, and interface components. In certain scenarios in which radio network node 900 comprises multiple separate components (e.g., BTS and BSC components), one or more of the separate components may be shared among several network nodes. For example, a single RNC may control multiple NodeB's. In such a scenario, each unique NodeB and BSC pair, may be a separate network node. In some embodiments, radio network node 900 may be configured to support multiple radio access technologies (RATs). In such embodiments, some components may be duplicated (e.g., separate memory 904 for the different RATs) and some components may be reused.

The radio network node 900 is configured to perform at least one of the method embodiments performed by a radio network node as described above, e.g. method 500 of FIG. 5 and method 700 of FIG. 7. The radio network node 900 is associated with the same technical features, objects and advantages as the previously described method embodiments.

The radio network node may be implemented and/or described as follows:

Radio network node 900 comprises processing circuitry 901, and one or more communication interfaces 902. For example, the communication interface 902 may comprise one or more interfaces for transmitting one or more communications/signals with beamforming on a set of subbands or subcarriers, and to initiate requests to a mobile device to perform positioning. The one or more interfaces of communication interface 902 may also receive wireless communications from other devices, e.g. reference signals from a mobile device for performing positioning measurements, as well as, measurement reports comprising measurements for two or more frequency bands for positioning of the mobile device. The processing circuitry may be composed of one or more parts which may be comprised in one or more nodes in the communication network, but is here illustrated as one entity.

The processing circuitry 901 is configured to cause the radio network node 900 to schedule frequency resources in an angular positioning measurement configuration for two or more frequency bands. The processing circuitry 901 is further configured to initiate a request to a mobile device to perform positioning measurements for the two or more frequency bands according to the angular positioning configuration. The processing circuitry 901 is further configured to receive a measurement report according to a reporting configuration in response to the request, where the measurement report comprises positioning measurements for the two or more frequency bands, and further to determine refined mobile position related information based on the measurement report.

The processing circuitry 901 may, as illustrated in FIG. 9B, comprises one or more processing means, such as a processor 903, and a memory 904 for storing or holding instructions. In an embodiment of FIG. 9B, the memory may comprise instructions, e.g. in form of a computer program 905, which when executed by the one or more processors 903 causes the radio network node 900 to perform the actions and methods described above, e.g. the methods illustrated in FIG. 5 and FIG. 7.

An alternative implementation of the processing circuitry 901 is shown in FIG. 9C, e.g. corresponding to method 500 of FIG. 5. The processing circuitry 903 comprises a scheduling unit 906, configured to cause the radio network node to schedule frequency resources in an angular positioning measurement configuration for two or more frequency bands. The processing circuitry 901 may further comprise an initiating unit 907, configured to initiate a request to a mobile device to perform positioning measurements for the two or more frequency bands according to the angular positioning configuration. The processing circuitry 901 may further comprise a receiving unit 908, configured to receive a measurement report according to a reporting configuration in response to the request, where the measurement report comprises positioning measurements for the two or more frequency bands. The processing circuitry 901 may further comprise a determining unit 909, configured to determine refined mobile position related information based on the measurement report.

Another second alternative implementation of the processing circuitry 901 is shown in FIG. 9C, e.g. corresponding to method 700 of FIG. 7. The processing circuitry 903 comprises the scheduling unit 906, further configured to cause the radio network node to schedule frequency resources in a reference signal transmission configuration for two or more frequency bands. The processing circuitry 901 may further comprise a transmitting unit 910, configured to transmit an initiation request to a mobile device to perform uplink reference signal transmission according to the for the reference signal transmission configuration. The processing circuitry 901 may also comprise a processing unit 911, configured to process received uplink reference signals from the mobile device for the two or more frequency bands. The processing circuitry 901 comprising the determining unit 909, may be further configured to determine refined mobile position related information based on the processed received uplink reference signals.

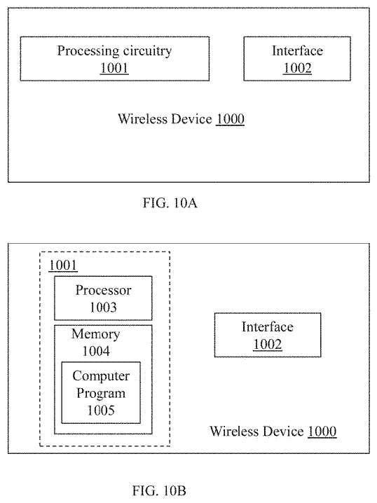

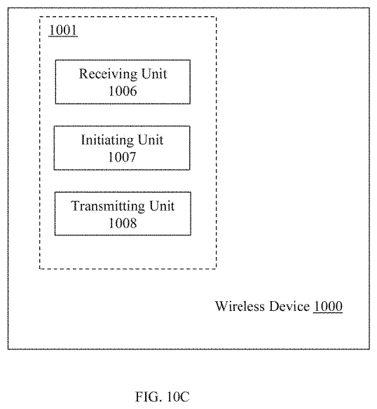

An exemplifying embodiment of a wireless device is illustrated in a general manner in FIG. 10A. Wireless device (WD) 1000 may be any type of wireless endpoint, mobile station, mobile phone, wireless local loop phone, smartphone, user equipment (UE), desktop computer, PDA, cell phone, tablet, laptop, VoIP phone or handset, which is able to wirelessly send and receive data and/or signals to and from a network node, such as radio network node 120 and/or other WDs. Like radio network node 900, the components of wireless device 1000 are depicted as single boxes located within a single larger box, however in practice a wireless device may comprises multiple different physical components that make up a single illustrated component (e.g., memory 1004 may comprise multiple discrete microchips, each microchip representing a portion of the total storage capacity).

The wireless device 1000 is configured to perform at least one of the method embodiments performed by a wireless device as described above, e.g. method 600 of FIG. 6 and method 800 of FIG. 8. The wireless device 1000 is associated with the same technical features, objects and advantages as the previously described method embodiments.

The wireless device may be implemented and/or described as follows:

Wireless device 1000 comprises processing circuitry 1001, and one or more communication interfaces 1002. For example, the communication interface 1002 may comprise one or more interfaces for transmitting one or more communications/signals according to a reference signal transmission configuration, and also for transmitting measurement reports for two or more frequency bands. The one or more interfaces of communication interface 1002 may also receive wireless communications from other devices, e.g. initiation requests to initiate measurements for positioning based on two or more frequency bands, or to initiate reference signal transmission for positioning based on two or more frequency bands. The processing circuitry may be composed of one or more parts which may be comprised in one or more nodes in the communication network, but is here illustrated as one entity.

The processing circuitry 1001 is configured to cause the wireless device 1000 to receive an initiation request from radio network node 900 comprising an angular positioning measurement configuration for two or more frequency bands. The processing circuitry 1001 is further configured to, in response to the request, initiate measurements for the two or more frequency bands according to the angular positioning measurement configuration. The processing circuitry 1001 is further configured to transmit a measurement report in response to the request, the measurement report based on the measurements for the two or more frequency bands.

The processing circuitry 1001 may, as illustrated in FIG. 10B, comprises one or more processing means, such as a processor 1003, and a memory 1004 for storing or holding instructions. In an embodiment of FIG. 10B, the memory may comprise instructions, e.g. in form of a computer program 1005, which when executed by the one or more processors 1003 causes the radio network node 1000 to perform the actions and methods described above, e.g. the methods illustrated in FIG. 6 and FIG. 8.

One implementation of the processing circuitry 1001 is shown in FIG. 10C, e.g. corresponding to method 600 of FIG. 6. The processing circuitry 1003 comprises a receiving unit 1006, configured to cause the wireless device 1000 to receive an initiation request from a radio network node comprising an angular positioning measurement configuration for two or more frequency bands. The processing circuitry 1001 may further comprise an initiating unit 1007, configured to, in response to the request, initiate measurements for the two or more frequency bands according to the angular positioning measurement configuration. The processing circuitry 1001 may further comprise a transmitting unit 1008, configured to transmit a measurement report in response to the request, the measurement report based on the measurements for the two or more frequency bands.

An alternative implementation of the processing circuitry 1001 is shown in FIG. 10C, e.g. corresponding to method 800 of FIG. 8. The processing circuitry 1003 comprises the receiving unit 1006, further configured to cause the wireless device 1000 to receive an initiation request from a radio network node comprising reference signal transmission configuration for two or more frequency bands. The processing circuitry 1001 may further comprise an initiating unit 1007, configured to initiate reference signal transmission according to the reference signal transmission configuration.

The steps, functions, procedures, modules, units and/or blocks described for the radio access device herein may be implemented in hardware using any conventional technology, such as discrete circuit or integrated circuit technology, including both general-purpose electronic circuitry and application-specific circuitry.

Alternatively, at least some of the steps, functions, procedures, modules, units and/or blocks described above may be implemented in software such as a computer program for execution by suitable processing circuitry including one or more processing units, i.e. processing circuitry 901. The software could be carried by a carrier, such as an electronic signal, an optical signal, a radio signal, or on a non-transitory computer readable storage medium before and/or during the use of the computer program e.g. in one or more nodes of the wireless communication network.

The flow diagram or diagrams presented herein may be regarded as a computer flow diagram or diagrams, when performed by one or more processors. A corresponding radio access device or apparatus may be defined as a group of function modules, where each step performed by a processor corresponds to a function module. In this case, the function modules are implemented as one or more computer programs running on one or more processors.

Examples of processing circuitry 901 of a radio network node 900 and 1001 of wireless device 1000 may include, but is not limited to, a combination of one or more of a microprocessor, controller, microcontroller, central processing unit (CPU), digital signal processor (DSP), application specific integrated circuit (ASIC), field programmable gate array (FPGA), Programmable Logic Controllers (PLCs), or any other suitable computing device, resource, or combination of hardware, software and/or encoded logic operable to provide, either alone or in conjunction with other components, such as memory 904 and/or 1004, the functionality of the radio network node 900 and/or wireless device 1000. That is, the units or modules in the arrangements in the communication network described above could be implemented by a combination of analog and digital circuits in one or more locations, and/or one or more processors configured with software and/or firmware, e.g. stored in a memory. One or more of these processors, as well as the other digital hardware, may be included in a single application-specific integrated circuitry, ASIC, or several processors and various digital hardware may be distributed among several separate components, whether individually packaged or assembled into a system-on-a-chip, SoC.

The memory 904 and 1004 may comprise any form of volatile or non-volatile computer, or non-transitory computer readable media including, without limitation, persistent storage, solid state memory, remotely mounted memory, magnetic media, optical media, random access memory (RAM), read-only memory (ROM), removable media, or any other suitable local or remote memory component. Memory 904 and 1004 may store any suitable instructions, data or information, including software and encoded logic, to be executed by the processing circuitry 901 and 1001 so as to implement the above-described functionalities of the radio access device 900 and/or wireless device 1000. Memory 904 and 1004 may be used to store any calculations made by processor 903 and 1003 and/or any data received via interface.

It should also be understood that it may be possible to re-use the general processing capabilities of any conventional device or unit in which the specific proposed technology is implemented. It may also be possible to re-use existing software, e.g. by reprogramming of the existing software or by adding new software components in order to implement the specific features of the proposed technological solution.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

When using the word “comprise” or “comprising” it shall be interpreted as non-limiting, i.e. meaning “consist at least of”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

In a fifth aspect (e.g. when positioning of the mobile device is performed in the mobile device, based on DL measurements), a method of a radio network node for positioning of the mobile device comprises: scheduling of frequency resources in an angular positioning measurement configuration for two or more frequency bands; and transmitting the scheduling data of the frequency resources for the angular measurement and/or an initiation request to the mobile device to perform positioning based on transmitted downlink (DL) signals organized according to the angular positioning measurement configuration. The method further comprises receiving a position report comprising the position of the mobile device. In an embodiment of the method, the downlink reference signals are any of: positioning reference signals, synchronization signals, physical signals comprised in Synchronization Signal (SS) block, Demodulation Reference Signal (DM-RS), Phase Tracking Reference Signal (PT-RS), tracking reference signals or signals used for time frequency tracking (TRS), CSI-RS or CSI-RS equivalent signals.

In a sixth aspect, a method of a mobile device for positioning of the mobile device comprises: receiving an initiation request from a radio network node to perform positioning based on downlink (DL) signals transmitted according to the angular positioning measurement configuration for two or more frequency bands; initiating positioning measurements on the received DL signals transmitted according to the angular positioning measurement configuration; determining refined mobile position related information based on the positioning measurements; and transmitting of refined position related information to a positioning network node in a position report according to a reporting configuration, wherein the positioning network node and the radio network node are separate nodes. In an embodiment of the method, in which complete positioning is performed in the mobile device, the method further comprises obtaining a subset of a fingerprint database to be used for positioning; determining a position of the mobile device using the subset of the fingerprint database and the refined mobile position related information; and transmitting a position report to a positioning network node, the position report comprising the determined position.

In a seventh aspect, a method of a positioning network node comprises: transmitting a positioning request to a radio network node associated with a mobile device, the positioning request indicating a request for the mobile device to perform mobile based positioning based on AoA in two or more frequency bands; and receiving, via LTE Positioning Protocol (LPP), a position report from the mobile device, the position report comprising the determined mobile position. In another embodiment when complete positioning is performed in the network node (e.g. base station), the method comprises: obtaining, by the network node, at least parts of a fingerprint database to be used for positioning; and determining the position of the mobile device using the fingerprint database and the refined mobile position related information. The method further comprises transmitting a position report to the positioning network node, comprising the determined position. In a further embodiment, the position report is transmitted via an LPPa protocol message.

In an eighth aspect, a method of a positioning network node comprises: transmission of a positioning request to a radio network node associated with a mobile device, indicating a request to perform network node based positioning of the mobile device based on AoA in two or more frequency bands; and reception of a position report from the network node, comprising the determined mobile position. In a further embodiment, the position report is received via an LPPa protocol message.

In a ninth aspect, a method of a positioning node (e.g. positioning of a mobile device is performed in the positioning node, with data from base station node over LPPa in LTE), comprises: transmission of a positioning request to a radio network node associated with the mobile node, comprising a request for network node based positioning based on measurements in two or more frequency bands; and receiving, via LPPa, refined mobile position related information from the radio network node. In another embodiment, the refined mobile position related information is received via an LPPa protocol message.

In a tenth aspect, a method of a positioning node (e.g. positioning of the mobile device is performed in the positioning node, with data from UE over LPP in LTE) comprises: transmission of a positioning request to a radio network node associated with the mobile device, the request indicating mobile device based positioning based on AoA in two or more frequency bands; and receiving, via an LPP protocol (e.g. LPPa), refined mobile position related information from the mobile device.

1. A method of a radio network node for positioning a mobile device, the method comprising:
scheduling frequency resources in an angular positioning measurement configuration for two or more frequency bands;
initiating a request to the mobile device to perform positioning measurements for the two or more frequency bands according to the angular positioning measurement configuration;
receiving a measurement report according to a reporting configuration in response to the request, the measurement report comprising the positioning measurements for the two or more frequency bands; and
determining refined mobile position related information based on the measurement report.

2. The method of claim 1, wherein initiating the request comprises providing the mobile device with the angular positioning measurement configuration and transmitting downlink (DL) reference signals according to the angular positioning measurement configuration.

3. The method of claim 2, wherein a DL reference signal is transmitted for each frequency band of the two or more frequency bands.

4. The method of claim 2, wherein the downlink reference signals are any of: positioning reference signals, synchronization signals, physical signals comprised in Synchronization Signal (SS) block, Demodulation Reference Signal (DM-RS), Phase Tracking Reference Signal (PT-RS), tracking reference signals or signals used for time frequency tracking (TRS), CSI-RS and CSI-RS equivalent signals.

5. The method of claim 1, wherein the scheduling is in response to a positioning request from the mobile device or a positioning node.

6. The method of claim 1, wherein the refined mobile position related information is provided to a positioning node.

7. The method of claim 6, wherein the positioning node and the radio network node are separate nodes.

8. The method of claim 5, wherein the positioning node and the radio network node are the same node.

9. The method of claim 1, wherein the refined mobile position related information is used to construct a multi-band angle-of-arrival (AoA) fingerprint or to determine a position of the mobile device based on the multi-band AoA fingerprint.

10. The method of claim 1, wherein the measuring report comprises AoA related information for a subset of the two or more frequency bands.

11. The method of claim 1, wherein the angular positioning measurement configuration for the two or more frequency bands indicates the resources to be used for performing the measurements.

12. A radio network node for positioning a wireless device comprising:
processing circuitry configured to:
schedule frequency resources in an angular positioning measurement configuration for two or more frequency bands; and
initiate a request to the wireless device to perform positioning measurements for the two or more frequency bands according to the angular positioning measurement configuration;
an interface configured to receive a measurement report according to a reporting configuration in response to the request, the measurement report comprising the positioning measurements for the two or more frequency bands; and
the processing circuitry further configured to determine refined mobile position related information based on the measurement report.

13. (canceled)

14. A non-transitory computer readable medium comprising instructions stored in memory (904) which when executed by a processor, cause a radio network device (900) to perform operations comprising:
scheduling frequency resources in an angular positioning measurement configuration for two or more frequency bands;
initiating a request to a mobile device to perform positioning measurements for the two or more frequency bands according to the angular positioning measurement configuration;
receiving a measurement report according to a reporting configuration in response to the request, the measurement report comprising the positioning measurements for the two or more frequency bands; and
determining refined mobile position related information based on the measurement report.

15.-36. (canceled)

37. The non-transitory computer readable medium of claim 14, wherein initiating the request comprises providing the mobile device with the angular positioning measurement configuration and transmitting downlink (DL) reference signals according to the angular positioning measurement configuration, and
wherein a DL reference signal is transmitted for each frequency band of the two or more frequency bands.

38. The non-transitory computer readable medium of claim 37, wherein the downlink reference signals comprise one or more of: positioning reference signals, synchronization signals, physical signals comprised in Synchronization Signal (SS) block, Demodulation Reference Signal (DM-RS), Phase Tracking Reference Signal (PT-RS), tracking reference signals or signals used for time frequency tracking (TRS), CSI-RS and CSI-RS equivalent signals.

39. The non-transitory computer readable medium of claim 14, wherein the scheduling is in response to a positioning request from the mobile device or a positioning node.

40. The non-transitory computer readable medium of claim 14, wherein the refined mobile position related information is provided to a positioning node.

41. The non-transitory computer readable medium of claim 14, wherein the refined mobile position related information is used to construct a multi-band angle-of-arrival (AoA) fingerprint or to determine a position of the mobile device based on the multi-band AoA fingerprint.

42. The non-transitory computer readable medium of claim 14, wherein the measuring report comprises AoA related information for a subset of the two or more frequency bands.

43. The non-transitory computer readable medium of claim 14, wherein the angular positioning measurement configuration for the two or more frequency bands indicates the resources to be used for performing the measurements.
